(19) United States
(12) Patent Application Publication
(10) Pub. No.: US 2002/0178913 A1
(43) Pub. Date: Dec. 5, 2002

(54) Helium recovery process

(76) Inventors: Wenchang Ji, Doylestown, PA (US); Arthur I. Shirley, Hillsborough, NJ (US); Katy Ka-Yee Lee, New York, NY (US)

Correspondence Address: Philip H. Von Neida, The BOC Group, Inc., Intellectual Property Dept., 100 Mountain Ave., Murray Hill, NJ, 07974, US

(21) Appl. No.: 10/139,687

(22) Filed: May 3, 2002

Related U.S. Application Data
(63) Continuation-in-part of application No. 09/483,314, filed on Jan. 14, 2000, now abandoned.

(51) Int. Cl. B01D 53/02

(52) U.S. Cl. 95/96

(57) ABSTRACT

Improved methods for recovering helium gas from a multiple-stage consolidation furnace are disclosed. It has been discovered that a multi-valve can be actuated to respond to each of the stages of the consolidation furnace and their corresponding exhaust gases. By using this valve, the various exhaust gases can be directed to membrane separation units, PSAs, scrubbers and GRCs to remove, N₂, O₂, HCI, Cl₂ and H₂O from the gas streams and recover the helium gas.

The present application is a continuation-in-part application of Ser. No. 09/483,314, filed Jan. 14, 2000.

### FIELD OF THE INVENTION

The present invention provides for a process for recovering helium from a consolidation furnace in the production of optical fibers. More particularly, the present invention provides for the use of an actuated multi-valve assembly for separating and directing as for further treatment the exhaust gas from the multiple stages of the consolidation furnace.

### BACKGROUND OF THE INVENTION

Optical fiber manufacturing is basically a two-phase process that involves fabrication of a specially constructed glass rod called a preform and then melting the preform and drawing it into a thin fiber. Preform fabrication normally involves two steps, deposition and consolidation, that may be combined as one continuous operation or split into two separate ones.

Helium gas has three primary uses in optical fiber manufacture, a carrier gas in preform deposition, a sweep gas in preform consolidation and a heat transfer medium for fiber drawing. Each of these three process steps introduces different impurities, contaminant levels and/or heat levels into the helium gas. The traditional once-through helium flows (i.e. entering the general gas waste stream) used in optical fiber manufacturing processes are wasteful and result in excessive consumption and unnecessarily high cost.

Other consolidation processes, such as disclosed in U.S. Pat. No. 5,055,121, for producing glass preform, has fluorine selectively added to its cladding for optical fiber. This can lower the refractive index of the quartz glass without affecting transmission characteristics of the optical fiber. The glass preform is produced by the steps of deposition of soot of quartz glass on a pipe; dehydration; and vitrification and addition of fluorine.

Dehydration gases include chlorine and chlorine-containing compounds such as SOCl₂ and CCl₄. In the vitrification and fluorine addition step, fluorine-containing gases such as SF₆, CCl₂F₂, CF₄, C₂F₆ and SiF₄ are employed. To obtain the transparent glass preform containing no residual bubbles, helium is the preferred carrier gas for both dehydration and fluorine-addition steps as it is easily dissolved in the glass. Table I summarizes the gas flow rates and concentrations used in the production of glass preform as per the example of the '121 patent.

TABLE I

| | |
|---|---|
| Dehydration | Fluorine Addition |

| | | | | | |
|---|---|---|---|---|---|
| Cl₂ | 0.6 | l/mm (6%) | SiF₄ | 0.3 | l/mm (3%) |
| He | 10 | l/mm (94%) | He | 10 | l/mm (97%) |

A considerable portion of the chlorine and fluorine-containing gases may leave this process untreated and are currently abated by scrubbing with an alkaline solution. The helium exiting the process is released into the atmosphere. Helium is a non-renewable gas and is expensive. As such, it is highly desirable to recover and recycle the helium to reduce the cost of optical glass fiber production.

### SUMMARY OF THE INVENTION

The present invention provides for means for recovering helium from optical fiber preform drying and consolidation processes. These means comprise sealing means to limit air leaking into the exhaust gas stream; multi-multi-valve means utilized to separate the process exhaust streams from the multiple stages of consolidation; a membrane separation unit which can separate the helium from HCl, Cl₂, O₂ and N₂ in the exhaust gas; a pressure swing adsorption (PSA) unit which can remove N₂, O₂ and H₂O from helium; and a scrubber for treating residual HCl and Cl₂.

The present invention further provides for a method for treating gas exhausted from a consolidation furnace in which is formed a glass preform from which optical fiber is able to be made, the method comprising selecting by operation of valve means each one of a plurality of lines for treatment of the exhaust gas, wherein at least one of the treatment lines includes a gas separation unit for separating helium from the exhaust gas.

The method utilizes a first line for treating purge gas exhausted from the furnace, a second line for treating gas exhausted from the furnace during a dehydration stage, and a third line for treating gas exhausted from the furnace during a vitrification and/or fluorination stage. The helium separation unit will comprise a membrane unit for separating a mixture of helium and water vapor from said exhaust gas.

This aspect of the present invention will also provide for means to treat chlorine and HCl that are present in the exhaust gas, as well as any fluorine. These means can be a gas reactor column or a scrubber.

### BRIEF DESCRIPTION OF THE DRAWINGS

FIG. 1 depicts a multiple-stage consolidation furnace employed in producing optical fibers.

FIGS. 2 through 5 are schematic representations of embodiments of consolidation furnaces and exhaust gas treatment systems under which the present invention may be practiced.

### DETAILED DESCRIPTION OF THE INVENTION

The present invention provides for a method for recovering helium from a multiple-stage consolidation furnace. The stages in an optical fiber consolidation process may include purge with nitrogen, dehydration with chlorine/helium gas; vitrification with a nitrogen/helium gas mixture; and addition of fluorine with helium/fluorine containing gas mixture.

In a typical process for the recovery of helium from preform drying and consolidation, the exhaust gas mixture exiting the consolidation furnace comprises He, Cl₂HCl, N₂, O₂, H₂O, and fluorine-containing gas.

Typically, the preform will complete the above steps in the furnace. The top of the furnace is partially open and the process gases as noted enter the furnace at the bottom and exit near the top. Large amounts of air are sucked into the exhaust stream which is carried to the blower or the vacuum pump.

In one embodiment of the present invention, helium is recovered from a multiple-stage consolidation furnace comprising the steps of feeding the exhaust gas to a multi-valve; actuating the valve such that the exhaust gas from one stage of the consolidation process comprising He, Cl₂, HCl, O₂, N₂, and H₂O is directed to an abatement facility selected from an aqueous scrubber or gas reactor column; and recovering the helium gas by pressure swing adsorption (PSA) or membrane process. The multi-valve assembly is actuated such that the exhaust gas stream containing nitrogen is vented.

In another embodiment of the present invention, the exhaust gas is fed to a multi-valve assembly where the valve is actuated such that the nitrogen exhaust stream is vented from the valve. The exhaust gas from the stages of the consolidation which comprise He, Cl₂, HCl, O₂, N₂, H₂O and fluorine-containing gases is fed to a membrane module which removes helium gas and moisture and the remaining exhaust is then fed to an abatement facility which comprises either an aqueous scrubber or a gas recovery column which can remove the Cl₂ and HCl and vent N₂, O₂, and fluorine containing gases. The recovered helium is further treated by a dryer for recycle.

In another embodiment of the present invention, helium is recovered from a multiple consolidation furnace by the steps of feeding the exhaust gas from the furnace to a multi-valve assembly. The exhaust gas from this stage of the consolidation process comprising He, Cl₂, HCl, O₂, N₂ and H₂O is directed to a first membrane module where helium is separated and recovered. The multi-valve is actuated so that it can receive a nitrogen exhaust gas which it vents as well as the exhaust gas from the stage of consolidation process comprising He, N₂, O₂ and fluorine-containing gas which is stepwise directed to a second membrane module such that helium is separated and recovered. The exhaust gas from the second membrane module is further treated by the third membrane module so that fluorine-containing gas is separated from the gas mixture and is recovered for recycle.

In a further embodiment of the present invention, helium is recovered from a multiple consolidation furnace from the steps of directing the exhaust gas from the stage of the consolidation furnace comprising He, Cl₂, HCl, O₂, N₂ and H₂O through a multi-valve to an abatement facility selected from the group consisting of a scrubber or GRC, and further to a dryer if an aqueous scrubber is employed. Meanwhile, the stage exhaust comprising He, N₂ ,O₂ and fluorine-containing gases is directed through the multi-valve to a line leading from the abatement facility where it joins the gases from the dryer. This combination is directed to a PSA or membrane or combination thereof where helium is separated and recovered.

The phrase “multi-valve” for purposes of the present invention is meant to include both multiple way valves and multi-valves.

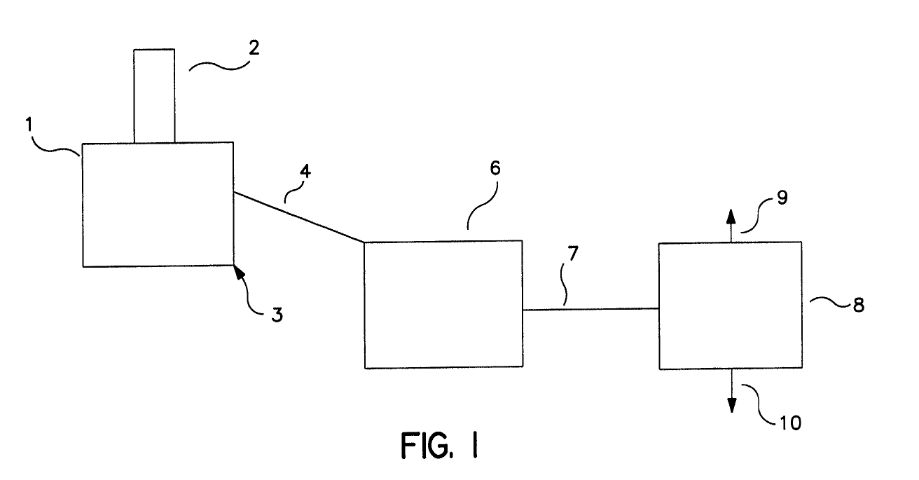

FIG. 1 is a schematic representation of a drying and consolidation process for preform fabrication. Furnace 1 contains the preform 2 which is traveling from top to bottom of the furnace. Line 3 enters the bottom of the furnace and carries the varieties of gases and gas mixture employed in the furnace.

Line 4 is the exhaust gas line which relieves the furnace of gases such as He, Cl₂, HCl, O₂, and N₂ and directs them to a vacuum pump or blower 6 which further leads the gases through line 7 to an abatement facility 8. Typically, the abatement facility is a scrubber where the contaminated water, after contact with the gas stream, exits through line 9 and the purified gases exit through line 10.

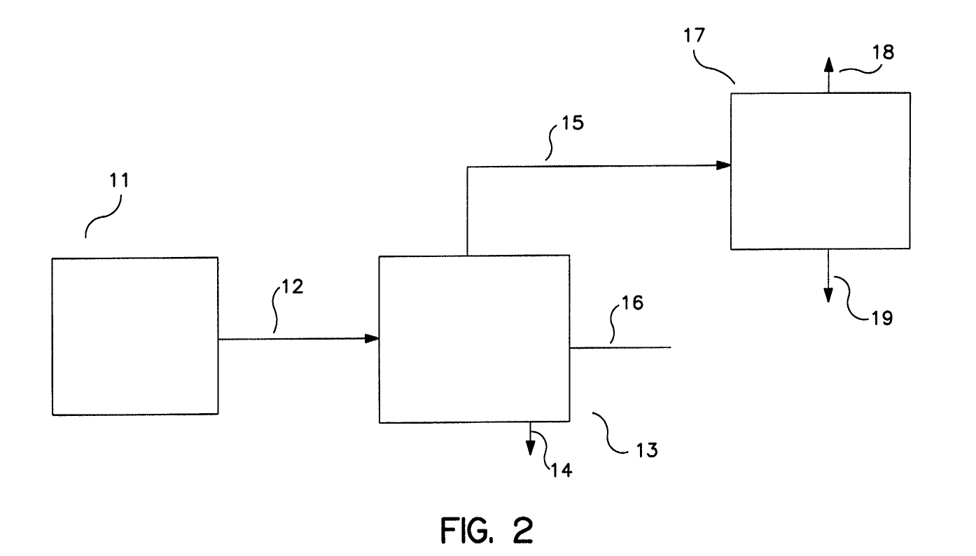

FIG. 2 is a schematic representation of a first aspect of the present invention. Line 12 carries waste gases from the vacuum pump 11 to a four-way valve 13. The four-way valve separates the gases from the exhaust stream per each of the three stages of the consolidation. Thus, N₂ exits through line 14; He, Cl₂, HCl, O₂, and N₂ exit through line 15; and He, O₂, N₂ or SiF₄ exit through line 16. Line 15 runs to an abatement facility 17 which can be either a scrubber or GRC. He is separated from N₂, O₂ and H₂O by PSA after passing the scrubber or GRC.

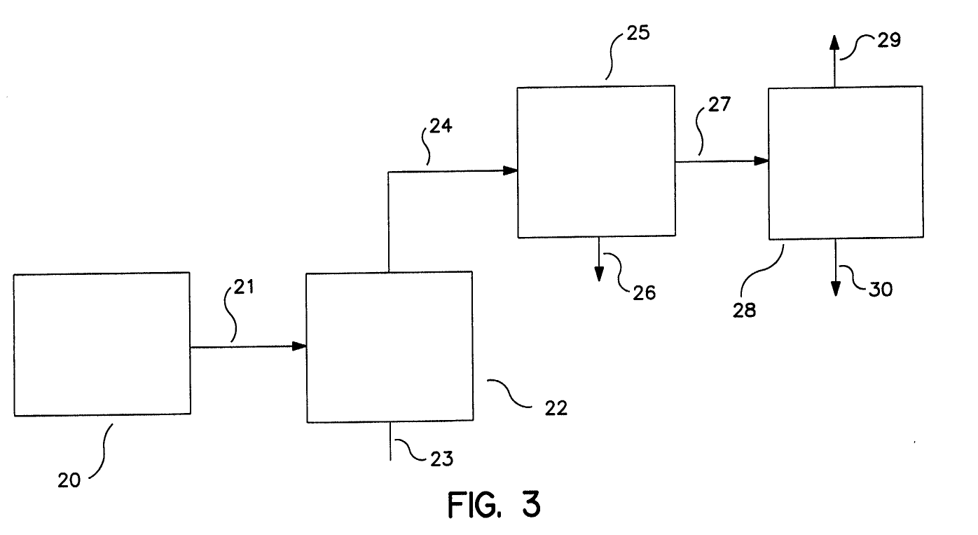

FIG. 3 is a schematic representation of another aspect of the present invention. The vacuum pump 20 delivers through line 21 the waste gases from the consolidation furnace to a three-way valve 22. Line 23 vents the N₂ gas from the waste gas and line 24 directs the remaining gases (Cl₂, HCl, He, O₂, N₂, H₂O and fluorine-containing gases) to a membrane module 25. Line 26 receives the helium from the membrane and line 27 directs the remaining gases to an abatement facility 28 which is a scrubber or a GRC. The recovered helium is further treated by a dryer before recycle.

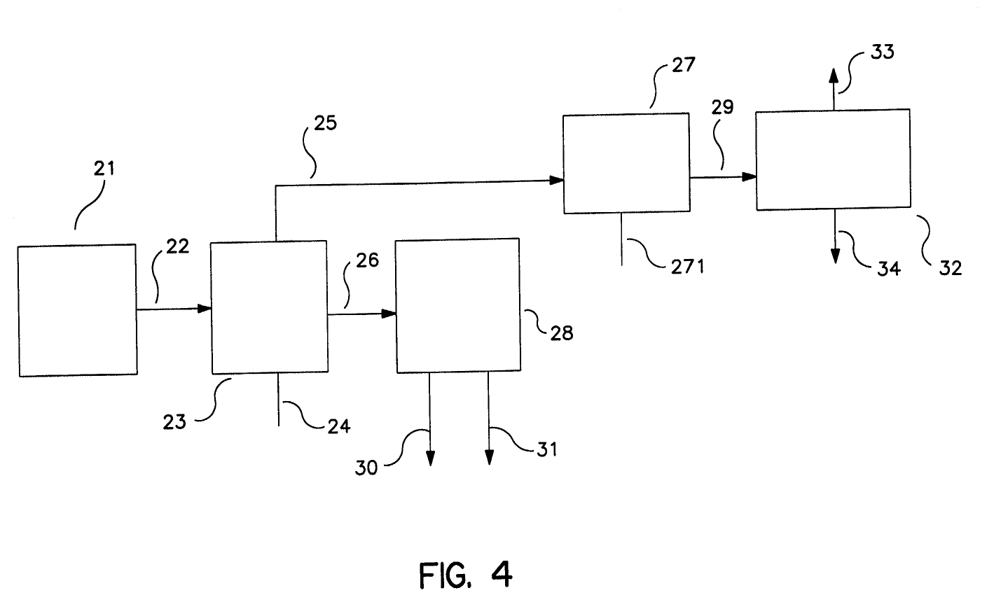

FIG. 4 is a schematic representation of another aspect of the present invention. Waste gases from the consolidation furnace travel from a vacuum pump 21 through line 22 to four-way valve 23. Line 24 vents part of the N₂ and line 25 delivers He, Cl₂, HCl, O₂, N₂, and H₂O to a first membrane module 27 where He is removed through line 271. The recovered helium is further treated by a dryer for recycle. Cl₂, HCl, O₂, and N₂ are delivered through line 29 to a scrubber or GRC 32. Line 26 directs He, O₂, N₂ or fluorine-containing gases from the four-way valve and to a second membrane module 28 where helium is removed through line 30 and O₂, N₂ or fluorine-containing gases are vented through line 31. Fluorine-containing gases can be separated from the gas mixture by the third membrane module for recycle.

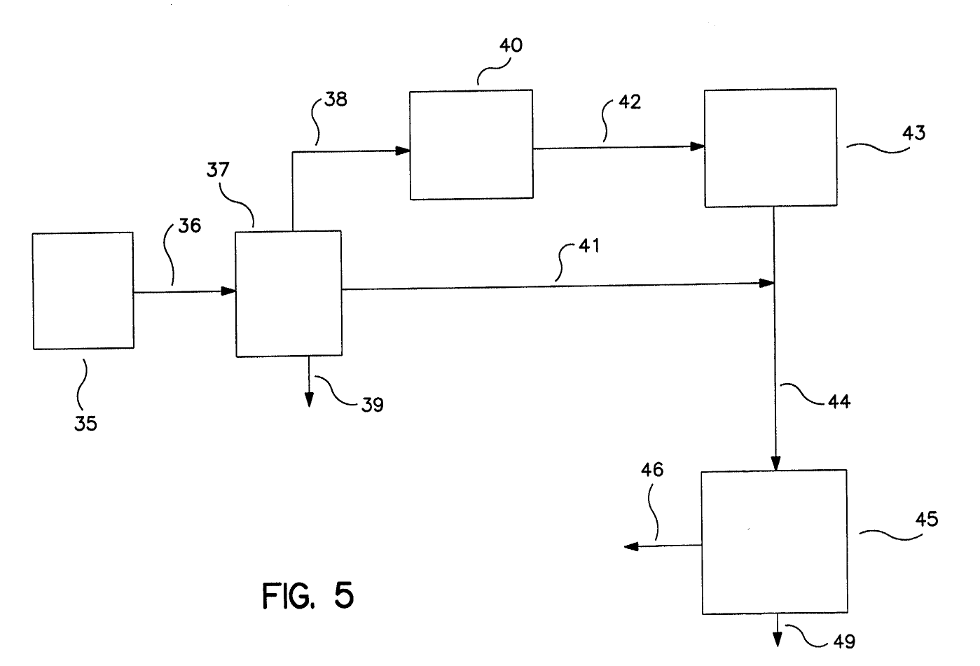

FIG. 5 is a schematic representation of another aspect of the present invention. Vacuum pump 35 delivers the waste gases from the consolidation furnace through line 36 to a four-way valve 37 where N₂ is vented through line 39 and He, Cl₂, HCl, O₂, and N₂ are vented through line 38 to an abatement facility 40, either a scrubber or a GRC. The dryer 43 is connected to the scrubber through line 42 where He, H₂O, N₂ and O₂ exit the scrubber and He, N₂ and O₂ exit through line 44.

Line 41 is connected to the four-way valve and carries He, N₂ and O₂. This line connects with line 44 which in turn connects to a helium-separation unit such as a PSA or membrane 45 where O₂ and N₂ exit through line 46 and recovered He exits through line 47.

One advantage employed in the methods of the present invention involves sealing means for sealing the opening where the preform enters the furnace. This not only improves efficiency of the consolidation furnace but also affects the later-claimed treatments as fewer impurities from air enter the system and are directed via exhaust to the treatment facilities.

Membrane modules are employed to separate helium from Cl₂, HCl, N₂, and O₂. Other membranes may be employed in the methods of the present invention particularly when fluorine containing gases such as SiF₄, SF₆, CCl₂F₂, CF₄, and C₂F₆ are present in the exhaust. In the methods of the present invention, for example, a first membrane may be employed to separate helium from Cl₂, HCl, N₂, and O₂. A second membrane may be employed to separate helium from O₂, N₂, and fluorine-containing gases. A subsequent third membrane may be employed to separate fluorine-containing gases from N₂ and O₂.

Traditional aqueous scrubbers may be employed in the methods of the present invention after treatment. The abatement facility may also employ gas reactor column (GRC) technology. This technology is employed for exhaust stream containing both HCl and Cl₂ and may offer advantages over traditional scrubbers in treating these gas streams. The hot, dry GRC system converts the hazardous organic and reactive halides to non-hazardous solids. A two cartridge heater unit in tandem will provide 100% up time on exhaust treatment and will destroy hazardous gases to below threshold limit values (TLV—0.5 ppm for CL₂ and 0.5 ppm for HCl). The GRC treated gases can be fed to a gas separation unit such as a PSA or membrane directly and without further treatment.

One example of a PSA is for removal of N₂, O₂ and moisture from helium. The PSA helium recovery process separates air from helium by preferential adsorption/desorption of nitrogen and oxygen. Zeolite molecular sieves are employed as adsorbents and include, for example, 13X, CaX, 4A, 5A, etc.

While this invention has been described with respect to particular embodiments thereof, it is apparent that numerous other forms and modifications of the invention will be obvious to those skilled in the art. The appended claims and this invention generally should be construed to cover all such obvious forms and modifications which are within the true spirit and scope of the present invention.

Having thus described the invention, what we claim is:

1. A method for treating gas exhausted from a consolidation furnace in which is formed a glass preform from which optical fiber is able to be made, the method comprising selecting by operation of valve means each one of a plurality of lines for treatment of the exhaust gas, wherein at least one of the treatment lines includes a gas separation unit for separating helium from the exhaust gas.

2. The method as claimed in claim 1 wherein said multiple stage consolidation furnace comprises sealing means at the exhaust gas outlet of said furnace to limit air infiltration into the exhaust gas.

3. The method as claimed in claim 1, in which there is a first line for treating purge gas exhausted from the furnace, a second line for treating gas exhausted from the furnace during a dehydration stage, and a third line for treating gas exhausted from the furnace during a vitrification and/or fluorination stage.

4. The method as claimed in claim 1 wherein said helium separation unit comprises a membrane unit for separating a mixture of helium and water vapor from said exhaust gas.

5. The method as claimed in claim 1 further comprising means for treating chlorine and HCl present in said exhaust gas.

6. The method as claimed in claim 5 wherein said treating means are selected from the group consisting of a gas reactor column and a scrubber.

7. The method as claimed in claim 6 further employing said treating means to remove fluorine from the exhaust gas.

8. A method for recovering and recycling helium from a multiple-stage consolidation furnace comprising the steps of:
a) feeding the exhaust gas from said furnace to a multi-valve assembly;
b) separating said exhaust gas from each stage of the consolidation process in said valve;
c) feeding the exhaust gas from each stage of said consolidation process to a helium separation unit; and
d) recovering and recycling said helium gas to said consolidation furnace.

9. The method as claimed in claim 8 wherein said multiple stage consolidation furnace comprises sealing means at the exhaust gas outlet of said furnace to limit air infiltration into the exhaust gas.

10. The method as claimed in claim 8 wherein said helium separation unit comprises a membrane unit for separating a mixture of helium and water vapor from said exhaust gas.

11. The method as claimed in claim 8 further comprising actuating said valve such that N₂ is separated from said exhaust gas and vented.

12. The method as claimed in claim 8 wherein said exhaust gas comprises He, Cl₂, HCl, O₂, N₂, and H₂O.

13. The method as claimed in claim 8 comprising removal of H₂O from helium by a dryer.

14. The method as claimed in claim 8 further comprising feeding said Cl₂, HCl, O₂, N₂ components from said membrane module to a scrubber or a gas reactor column.

15. A method for recovering and recycling helium from a multiple stage consolidation furnace comprising the steps of:
a) feeding the exhaust gas from said furnace to a multi-valve assembly;
b) separating said exhaust gas from each stage of the consolidation process in said valve;
c) feeding the exhaust gas from the first stage of said consolidation process to a first membrane module;
d) feeding the exhaust gas from the second stage of said consolidation process to a second membrane module;
e) recovering said helium gas from said first and said second membrane modules and recycling said helium gas to said consolidation furnace.

16. The method as claimed in claim 15 wherein said multiple stage consolidation furnace comprises sealing means at the exhaust gas outlet of said furnace to limit air infiltration into the exhaust gas.

17. The method as claimed in claim 15 wherein said first membrane module is a helium separation unit for separating a mixture of helium and water vapor from said exhaust gas.

18. The method as claimed in claim 17 comprising removal of H₂O from helium by a dryer.

19. The method as claimed in claim 15 further comprising actuating said valve such that N₂ is separated from said exhaust gas and vented.

20. The method as claimed in claim 15 wherein said exhaust gas comprises He, Cl₂, HCl, O₂, N₂, and H₂O.

21. The method as claimed in claim 15 wherein said second membrane module is selected from the group consisting of a scrubber and a gas reactor column.
